(19) United States
(12) Patent Application Publication
(10) Pub. No.: US 2015/0209692 A1
(43) Pub. Date: Jul. 30, 2015

(54) PROCESS AND APPARATUS FOR PURIFYING PROCESS WATER IN A HYDROTHERMAL CARBONIZATION PROCESS

(71) Applicant: AVA-CO2 Schweiz AG, Zug (CH)

(72) Inventor: Jan Vyskocil, Zug (CH)

(73) Assignee: AVA-CO2 SCHWEIZ AG, Zug (CH)

(21) Appl. No.: 14/421,537

(22) PCT Filed: Aug. 15, 2013
(86) PCT No.: PCT/EP2013/067067

§ 371 Date: Feb. 13, 2015

(30) Foreign Application Priority Data
Aug. 15, 2012 (DE) 10 2012 107 471.2

(51) Int. Cl. B01D 21/00; B01D 3/00; C02F 1/04; C10L 9/08; C02F 1/02

(52) U.S. Cl. CPC B01D 21/0087; C10L 9/086; C02F 1/025; C02F 1/04; B01D 3/00; C10L 2290/06; C10L 2290/08; C10L 2290/146; C10L 2290/56; C02F 2103/00

(57) ABSTRACT

Hydrothermal carbonization allows the production of charcoal from biomass. However, this biomass can at the beginning of the carbonization process contain constituents which are not suitable for carbonization. Apart from large contaminants such as broken glass, etc., these constituents are, in particular, sand and clay, with the clay not being able to be removed by simple filtration methods because of its fineness. The invention therefore provides for process water to be taken from the reaction space and subjected to purification in a sedimentation filter after the carbonization reaction has commenced and the clay is no longer held in the biomass. The process water is then sprayed back into the reaction space in order to keep the biomass/process water mixture in motion and avoid sedimentation of the clay at the bottom of the reaction space.

The present invention relates to a method and an apparatus for purification of process water within a hydrothermal carbonization process, in which process water and biomass are introduced into a reaction space, wherein filtering of the process water takes place by way of a sedimentation filter arrangement.

The state of the art already knows such a solution from DE 10 2007 062 808 A1. According to the teaching of this document, a reactor is provided for carrying out a hydrothermal carbonization reaction, during the course of which carbon is supposed to be produced from a mixture of process water and biomass. While the hydrothermal carbonization is carried out within the reactor, filtering of the reaction mixture of process water and biomass is provided for, in this connection, which filtering takes place using one or more hydrocyclones that lie on the inside. This filter apparatus is provided in the reactor, in which the reaction mixture is kept moving using a stirring mechanism. The stirring mechanism is disposed within a tube that lies on the inside, so that a vortex is formed in the reactor.

Despite the use of such a stirring mechanism, according to the teaching of this document the problem still has to be handled that sedimentation of undesirable components takes place at the bottom of the reactor, so that after the reactor is emptied, it must be freed of the sediments, using dry ice purification.

The reaction mixture, which consists of process water and biomass, comprises fundamentally any carbonaceous material, with regard to the biomass. This material can contain different substances, depending on its origin, which are not suitable for carbonization, either because they are simply contaminants, such as broken glass, screws, coins and the like, or because they are contained in, the substances used as biomass. With regard to the latter components, these can be sand, silt and the like, for example, which are firmly held in the biomass, in part.

Sand and silt, in particular, certainly make up a significant portion of the biomass used for the hydrothermal carbonization reaction, so that it is certainly practical to get these components out of the resulting product as completely as possible. In particular, these components also make no contribution toward the fuel value, so that a higher proportion of sand and silt in the resulting bio-coal results in a lower fuel value of the resulting coal product, in the end result.

A partial problem has already been solved by the document DE 10 2007 062 808 A1 mentioned above, in which sedimentation filtering of the process water takes place using a hydrocyclone. However, it must be stated that obviously, the use of a hydrocyclone for coarse or fine sifting of all solid particles contained in the process water achieves insufficient removal of sand and silt by means of the arrangement provided in the stated document, because in spite of these provisions, complicated post-treatment of the reactor by means of dry ice is required.

Against this background, the present invention is based on the task of clearly improving filtering of the process water, exclusively by means of the targeted removal of components such as sand or silt, which lower the quality of the bio-coal that is formed.

This task is accomplished by means of a method for purification of process water in accordance with the characteristics of claim 1. Likewise, this task is accomplished by means of an apparatus for purification of process water in accordance with the characteristics of the independent claim 7. Practical embodiments of method and apparatus can be derived from the dependent claims, in each instance.

According to the invention, it is provided that the hydrothermal carbonization process first begins with a mixture of process water and biomass in a reaction space, before extraction of process water from the reaction space takes place. When the hydrothermal carbonization reaction starts, fine components such as silt are released from the biomass, and thereby the possibility is created for releasing these components from the process water/biomass mixture, as well. After the carbonization reaction starts, the process water or the suspension is therefore extracted from the reaction space, for which purpose the reaction space has a process water extraction device in the bottom region, which device is connected with an extraction line. The extraction line passes the extracted process water on to a sedimentation filter arrangement, where filtering by means of sedimentation takes place.

The process water filtered in this manner is then returned to the reaction space by way of a return line, which are disposed in the bottom region of the reaction space, in a nozzle arrangement for jetting the process water into the reaction space.

By means of the bottom-side extraction of the process water from the reaction space, it is guaranteed that natural sedimentation is utilized during the hydrothermal carbonization process, in order to pass the process water that is most charged with sediments to filtering. Vice versa, the mixture of biomass and process water is swirled up by means of jetting the purified process water into the reaction space, using blow-in nozzles, without the need for a stirring mechanism or a similar mixing apparatus, in such a manner that for one thing, uniform mixing of the reaction mixture takes place, and for another, the particles that have already sedimented at the reactor bottom are swirled up again, in order to prevent them from caking onto the reactor. In this way, a sedimentation layer, which would then have to be removed in a separate work procedure, for example with dry ice, is prevented from forming at the bottom of the reactor, as it does in the state of the art. The great cooling of the reactor that accompanies dry ice purification, which puts extreme stress on the material, can thereby be clearly reduced or, in an ideal case, actually be eliminated entirely. For this purpose, it is necessary that the process water is jetted in at a sufficient pressure, while it is being jetted into the reaction space, so that swirling of the mixture can be brought about on the basis of the process water jet.

A hydrocyclone is used to some advantage as a sedimentation filter to which the process water is passed for purification, whereby it is also easily possible to use multiple hydrocyclones in parallel or one after the other for purification. Likewise, it is easily possible to serve multiple reaction spaces of an HTC system simultaneously with such a sedimentation filter arrangement.

The blow-in nozzle arrangement in the bottom region of the reaction space can consist of different types of blow-in nozzles, which preferably jet vertically into the reaction space, in order to give the process water/biomass mixture a strong movement impulse in terms of height, or are disposed tangential to the outside wall of the reaction space, in order to allow tangential acceleration to act on the mixture, resulting in swirling of the mixture in the reaction space. Both types of blow-in nozzles can also easily be present in the bottom region of the reactor and jet onto the mixture parallel or alternatively.

It is provided to supply the process water to the carbonization process in the form of steam, in order to thereby maintain the required temperature in the reaction space. If needed, renewed heating or steam production can take place after purification of the process water, so that the process water is supplied to the reaction space in steam form again, after having passed through the sedimentation filter arrangement.

Once again alternatively to or in series with the aforementioned sedimentation filter arrangement, a coarse filter, which allows pre-filtering of the mixture, can first be provided, to some advantage. For example, this can be a separator column that removes coarse undesired components from the reaction mixture.

The sedimentation filter arrangement can particularly consist of one or more hydrocyclones, whereby a parallel arrangement is desirable in the case where multiple hydrocyclones are used. In a preferred embodiment, this arrangement is disposed in a filter container that is divided into three chambers disposed one on top of the other. In this connection, the inflow of the process water takes place into a center chamber, into which the tangential inlets of the hydrocyclones open. By means of introduction of the process water into this center inflow chamber, the process water can therefore run into the respective hydrocyclone and flow downward there, in the direction of a lower funnel section, forming eddies. Because of the funnel-shaped design of the hydrocyclone, an upward movement forms in the center of the funnel, but this movement is not performed by the sedimenting components, which sink downward. While these components leave the hydrocyclone by way of a lower flow, which empties downward into a lower sediment chamber, the rising components of the process water are introduced into a tubular vortex finder, which represents a tube set vertically upright and empties from the hydrocyclone into an upper process water chamber. The process water is then removed from the upper process water chamber, into which only the purified process water together with the bio-coal that remains in it runs, and returned to the reaction space.

The invention described above will be explained in greater detail below, using an exemplary embodiment.

The drawing shows:

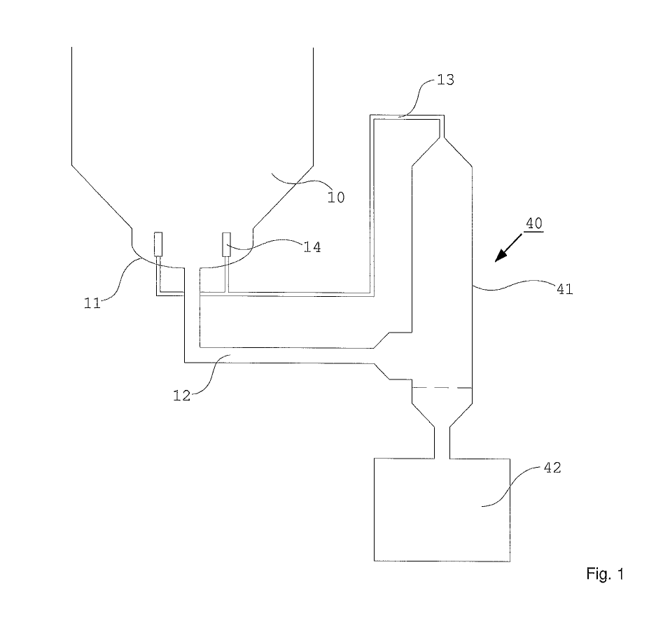

FIG. 1 a reaction space that is connected with a separator column for preliminary pre-filtering, and

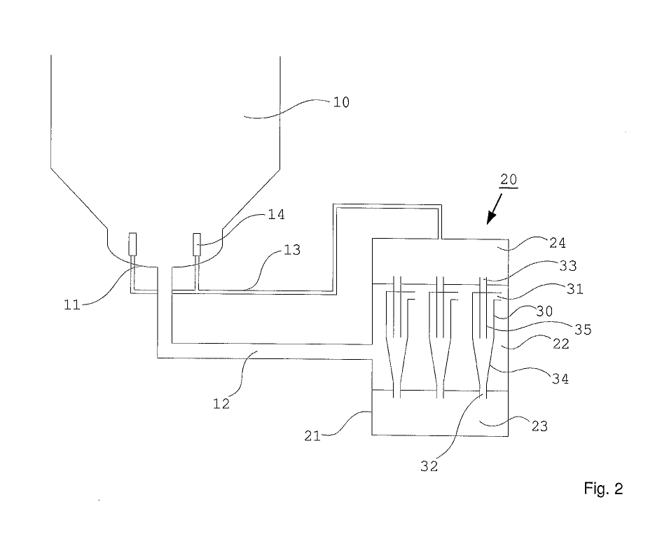

FIG. 2 a reaction space that is connected with a sedimentation filter arrangement consisting of multiple hydrocyclones, for fine filtering of the process water/biomass mixture.

FIG. 1 shows a reaction space 10 into which a mixture of process water and biomass was previously introduced. Within the scope of a first pre-filtering step shown here, part of the mixture, called the “slurry,” is passed to a separator column 40 by way of bottom-side extraction from the reaction space 10 and an extraction line 12 connected there. While the separator column 40 is filled, the hot process water will rise within a column section 41, while the heavier components, in other words the coarse contaminants, do not perform this upward movement and instead sink downward in the column section 41 and, in this manner, are brought into a sedimentation tank 42. The process water, which ultimately gets to the top side of the column section 41, is then returned to the reaction space 10 by way of a return line 13, and there blown back into the interior of the reaction space 10 by way of blow-in nozzles 14. In this connection, return of the process water, which is coarsely filtered, at first, can also take place by means of having it run in at the top side of the reaction space 10, whereby additional swirling using blow-in nozzles 14 within the scope of pre-filtering can be eliminated by means of such raining into the reaction space 10.

FIG. 2 shows the same reaction space 10, from which a mixture of process water and biomass can also be extracted by way of the extraction line 12, after the carbonization reaction has started. This mixture is then passed to a sedimentation filter arrangement 20, which is disposed in a filter container 21. In this connection, the extraction line 12 empties into a center inflow chamber 22, from which the mixture can run into a plurality of hydrocyclones 30 disposed in parallel, by way of a tangential inlet 31. After passing through the inlet 31 of a hydrocyclone 30, the process water to be purified will form an eddy within the hydrocyclone 30, because of the tangential movement of the water, and, at the same time, will sink downward under the effect of gravity. When doing so, it encounters a funnel section 34 of the hydrocyclone 30, which section, because of the small amount of space available, ensures that part of the process water rises again in the center of the hydrocyclone 30. At this location, there is a tubular vortex finder 35, by way of which the purified process water can run into a process water chamber 24 that lies at the top, through an upper flow 33. Because of the swirling within the hydrocyclone 30, the heavier components, specifically sand and silt and the like, are at first held up further outward on the hydrocyclone 30, and will then sink downward on the funnel wall of the funnel section 34, and finally are brought into a sedimentation chamber 23, by way of a lower flow 32. The purified process water from the process water chamber 24 that lies at the top is finally passed to an arrangement of blow-in nozzles 14, by way of a return line 13, which nozzles jet the process water/biomass mixture, which has been freed of sand and silt, into the reaction space 10. In this connection, the jet of the mixture is aimed at the mixture that is still situated in the reaction space 10, which mixture is sinking down under the effect of gravity, so that settling of sediments within the reaction space 10 is clearly reduced. If necessary, an evaporator can be disposed in the return line, in order to once again bring the mixture of the purified process water back to the temperature required for the reaction, before it is introduced into the reaction space 10.

Therefore a method and an apparatus for purification of process water have been described above, which provide for extraction of the process water, purification that lies on the outside, and blowing in of the purified process water in the bottom region of the reaction space, with the effect that sedimentation in the bottom region of the reaction space is prevented, the result of filtering is improved by means of the bottom-side extraction of the process water, and, at the same time, the design of the sedimentation filter arrangement is simplified by means of the arrangement that lies outside of the reaction space.

### REFERENCE SYMBOL LIST

10 reaction space
11 bottom
12 extraction line
13 return line
14 blow-in nozzle
20 sedimentation filter arrangement
21 filter container
22 inflow chamber
23 sedimentation chamber
24 process water chamber
30 hydrocyclone
31 inlet
32 lower flow
33 upper flow
34 funnel section
35 vortex finder
40 separator column
41 column section
42 sedimentation tank

1-13. (canceled)

14. An apparatus for purification of process water within a hydrothermal carbonization process, having a reaction space (10) in which a carbonization reaction takes place and a sedimentation filter arrangement (20) for purification of the process water, wherein a process water extraction device is disposed in the bottom region of the reaction space (10), which device is connected with the sedimentation filter arrangement (20), which lies on the outside, by means of an extraction line (12), and furthermore, a return line (13) from the sedimentation filter arrangement (20) to the reaction space (10) is provided, which line is connected, in the bottom region of the reaction space (10), with a nozzle arrangement for blowing the process water into the reaction space (10), wherein the sedimentation filter arrangement (20) comprises multiple hydrocyclones, which are accommodated in a filter container (21) having three chambers (22, 23, 24) disposed one on top of the other, wherein each hydrocyclone (30) comprises a tangential inlet (31) that empties into a center inflow chamber (22), a lower flow (32) that empties from a lower funnel section (34) of the hydrocyclone (30) into a lower sediment chamber (23), and an upper flow (33) that empties into an upper process water chamber (24) by way of a tubular vortex finder (35).

15. The apparatus according to claim 14, wherein the reaction space (10) is formed to be essentially cylindrical, preferably narrowing in funnel shape in the bottom region, wherein the process water extraction and/or the nozzle arrangement are disposed in a bottom (11) of the reaction space, which preferably represents the geodetically deepest location of the reaction space (10).

16. The apparatus according to claim 14, wherein the nozzle arrangement is formed by a plurality of blow-in nozzles (14) that are directed tangential to the walls of the reaction space and/or perpendicular into the reaction space.

17. The apparatus according to claim 14, wherein the return line (13) has an evaporator for evaporating the purified process water assigned to it.

18. The apparatus according to claim 14, wherein the reaction space (10) has an additional coarse filter, preferably in the form of a separator column (40), assigned to it, parallel or sequential to the sedimentation filter arrangement (20), wherein return of the process water from this additional coarse filter can optionally take place by way of the nozzle arrangement or by way of an inlet assigned to the reaction space (10) on the top side.
